(19) United States
(12) Patent Application Publication
(10) Pub. No.: US 2009/0096763 A1
(43) Pub. Date: Apr. 16, 2009

(54) TOUCH PANEL, DISPLAY DEVICE WITH INPUT FUNCTION, AND ELECTRONIC APPARATUS

(75) Inventor: Shoji Hinata, Matsumoto (JP)

Correspondence Address: HARNESS, DICKEY & PIERCE, P.L.C., P.O. BOX 828, BLOOMFIELD HILLS, MI, 48303, US

(73) Assignee: Epson Imaging Devices Corporation, Azumino-shi (JP)

(21) Appl. No.: 12/193,809

(22) Filed: Aug. 19, 2008

(30) Foreign Application Priority Data
Oct. 16, 2007 (JP) 2007-268677
Jun. 2, 2008 (JP) 2008-144366

(51) Int. Cl. G06F 3/044

(52) U.S. Cl. 345/174

(57) ABSTRACT

A touch panel includes: first and second substrates each having a first surface and a second surface, the second substrate being arranged on an input operation side of the first substrate; a first electrode that is formed on the first surface of the first substrate; a second electrode that is formed on the first surface of the second substrate; a resistive film type input area in which the first electrode of the first substrate and the second electrode of the second substrate face each other; and a capacitance type input area in which third electrodes are formed on at least one of the first substrate and the second substrate. The resistive film type input area and the capacitance type input area are separated from each other in plan view.

The entire disclosure of Japanese Patent Application Nos. 2007-268677, filed Oct. 16, 2007 and 2008-144366, filed Jun. 2, 2008 are expressly incorporated by reference herein.

### BACKGROUND

1. Technical Field

The present invention relates to a touch panel having a resistive film type input area capable of detecting a position where, for example, a finger is contacted, a display device with an input function including the touch panel, and an electronic apparatus.

2. Related Art

In recent years, electronic apparatuses in which an input device, which is called a touch panel, is provided on a liquid crystal display device, such as mobile phones, car navigation systems, personal computers, ticket machines, and banking terminals, have been developed. This type of electronic apparatus allows a user to input information while viewing an image displayed in an image display area of the liquid crystal display device.

Among these touch panels, a resistive film type touch panel includes a first substrate and a second substrate opposite to each other, and a first electrode and a second electrode are formed on surfaces of the first substrate and the second substrate facing each other. When the second substrate is pressed, a contact position between the first electrode and the second electrode is detected, thereby detecting input coordinates. In addition, there is a capacitance type touch panel which includes one substrate having an electrode formed thereon. In the capacitance type touch panel, when, for example, a finger contacts and approaches the touch panel, a variation in capacitance between the electrode and the finger is detected, thereby detecting input coordinates. Since the capacitance type touch panel is a non-contact type, it has high durability, unlike the resistive film type touch panel. However, the capacitance type touch panel has disadvantages in that it is difficult to input information with fingers or a pen.

In order to solve the above problems, a structure has been proposed in which a resistive film type touch panel and a capacitance type touch panel are separately manufactured, and overlap each other without any gap therebetween to detect plural kinds of pressed states (Japanese Unexamined Patent Application Publication No. 7-334308).

The inventors propose a touch panel that is capable of supporting various input methods, such as a method of scrolling the screen with fingers and inputting information with a pen, and has input areas arranged in a plane.

However, in the touch panel disclosed in Japanese Unexamined Patent Application Publication No. 7-334308 in which the resistive film type touch panel and the capacitance type touch panel are separately manufactured and overlap each other in plan view, since the touch panels are separately manufactured, manufacturing costs increases, and the thickness of the structure increases. In addition, an electrical connection area or frame areas surrounding the two touch panel areas increase, which results in a reduction in input area. Further, when the resistive film type touch panel and the capacitance type touch panel overlap each other in plan view and a display device is provided thereon, it is difficult to display different contents in an area used to scroll the screen and an area used for pen input. Therefore, it is difficult to appropriately display an input prompt.

### SUMMARY

An advantage of some aspects of the invention is that provides a technique for manufacturing a touch panel that is capable of supporting a plurality of input modes and has a large input area at a low cost.

Another advantage of some aspects of the invention is that provides a display device with an input function including the touch panel and an electronic apparatus including the touch panel.

According to an aspect of the invention, a touch panel includes: first and second substrates each having a first surface and a second surface, the second substrate being arranged on an input operation side of the first substrate; a first electrode that is formed on the first surface of the first substrate; a second electrode that is formed on the first surface of the second substrate; a resistive film type input area in which the first electrode of the first substrate and the second electrode of the second substrate face each other; and a capacitance type input area in which third electrodes are formed on at least one of the first substrate and the second substrate. The resistive film type input area and the capacitance type input area are separated from each other in a plan view.

In the above-mentioned structure, since one touch panel includes the resistive film type input area and the capacitance type input area, a user can input information by various input methods. For example, the user can scroll the screen with fingers in the capacitance type input area, and input information with a pen in the resistive film type input area. Therefore, usability is improved. Since the resistive film type input area and the capacitance type input area are arranged so as to be separated from each other in plan view, it is possible to perform optimum information input in both the resistive film type input area and the capacitance type input area. Further, since the third electrodes forming the capacitance type input area are formed on at least one of the first substrate and the second substrate on which the first and second electrodes forming the resistive film type input area are formed, it is possible to reduce manufacturing costs, as compared to a structure in which a resistive film type touch panel and a capacitance type touch panel are separately manufactured and arranged in a plane. In addition, since an electrical connection area and a frame area surrounding each input area are provided in a common area, it is possible to ensure a large input area.

In the touch panel according to the above-mentioned aspect, preferably, the third electrodes are formed on the first surface of the first substrate or the first surface of the second substrate. According to the above-mentioned structure, it is possible to form a conductive film required to form the capacitance type input area, for example, the third electrodes, some of the third electrodes, or a shield layer for the capacitance type input area, simultaneously with the first electrode or the second electrode. As a result, it is possible to improve productivity.

In the touch panel according to the above-mentioned aspect, preferably, a wiring member that outputs signals from the resistive film type input area and the capacitance type input area to the outside is connected to one of the first surface of the first substrate and the first surface of the second substrate on which the third electrodes are formed. According to the above-mentioned structure, the wiring member, such as a flexible substrate, may be connected to only the first surface of the substrate having the third electrodes formed thereon.

In the touch panel according to the above-mentioned aspect, preferably, a wiring member that outputs signals from the resistive film type input area and the capacitance type input area to the outside is connected to one of the first surface of the first substrate and the first surface of the second substrate on which the third electrodes are not formed, and an inter-substrate conductive material that outputs signals from the capacitance type input area to the outside is provided between the first surface of the first substrate and the first surface of the second substrate. According to the above-mentioned structure, the wiring member, such as a flexible substrate, may be connected to only the first surface of the substrate that is opposite to the substrate having the third electrodes formed thereon.

In the touch panel according to the above-mentioned aspect, preferably, the wiring member is connected to the first surface of the first substrate. The second substrate arranged on the input operation side needs to have flexibility and has a small thickness. Therefore, the second substrate is not suitable for connection to the wiring member. However, in the above-mentioned aspect of the invention, the wiring member is connected to the first substrate without these restrictions. Therefore, it is possible to form a connection portion having high reliability.

According to another aspect of the invention, a display device with an input function includes: the touch panel according to the above-mentioned aspect; and an image generating device that is provided on one surface of the first substrate of the touch panel opposite to the second substrate.

In the display device with an input function according to the above-mentioned aspect, preferably, at least one of the resistive film type input area and the capacitance type input area is a transmissive input area, and the image generating device includes an image display area that overlaps the transmissive input area.

In the display device with an input function according to the above-mentioned aspect, preferably, both the resistive film type input area and the capacitance type input area are transmissive input areas, and the image generating device includes an image display area that overlaps both the transmissive input areas.

In the display device with an input function according to the above-mentioned aspect, preferably, the image generating device includes a pair of substrates and an electro-optical material that is interposed between the pair of substrates, and the first substrate also serves as one of the pair of substrates. According to the above-mentioned structure, it is possible to reduce the number of substrates of the image generating devices or the touch panel, and thus reduce the thickness of the display device with an input function. In addition, for example, it is possible to divide an input area into an area used to scroll the screen and an area for pen input. Therefore, it is possible to switch images displayed by the image generating device according to the function of each input area. As a result, operability is improved.

The display device with an input function according to the above-mentioned aspect may be applied to various electronic apparatuses, such as mobile phones, car navigation systems, personal computers, ticket machines, and banking terminals.

### BRIEF DESCRIPTION OF THE DRAWINGS

The invention will be described with reference to the accompanying drawings, wherein like numbers reference like elements.

FIG. 1 is a diagram schematically illustrating the structure of a display device with an input function according to the invention.

FIG. 2 is a cross-sectional view schematically illustrating the structure of a display device with an input function according to a first embodiment of the invention.

FIG. 3 is a cross-sectional view schematically illustrating the structure of a display device with an input function according to a second embodiment of the invention.

FIG. 4 is a cross-sectional view schematically illustrating the structure of a display device with an input function according to a third embodiment of the invention.

FIG. 5 is a cross-sectional view schematically illustrating the structure of a display device with an input function according to a fourth embodiment of the invention.

FIG. 6 is a cross-sectional view schematically illustrating the structure of a display device with an input function according to a fifth embodiment of the invention.

FIG. 7 is a cross-sectional view schematically illustrating the structure of a display device with an input function according to a sixth embodiment of the invention.

FIGS. 8A to 8C are diagrams illustrating electronic apparatuses provided with the display device with an input function according to the embodiments of the invention.

FIG. 9 is a cross-sectional view schematically illustrating the structure of a display device with an input function according to a seventh embodiment of the invention.

### DESCRIPTION OF EXEMPLARY EMBODIMENTS

Hereinafter, exemplary embodiments of the invention will be described with reference to the accompanying drawings. In the following drawings, a scale of each layer or member is adjusted in order to have a recognizable size.

### First Embodiment

### Overall Structure

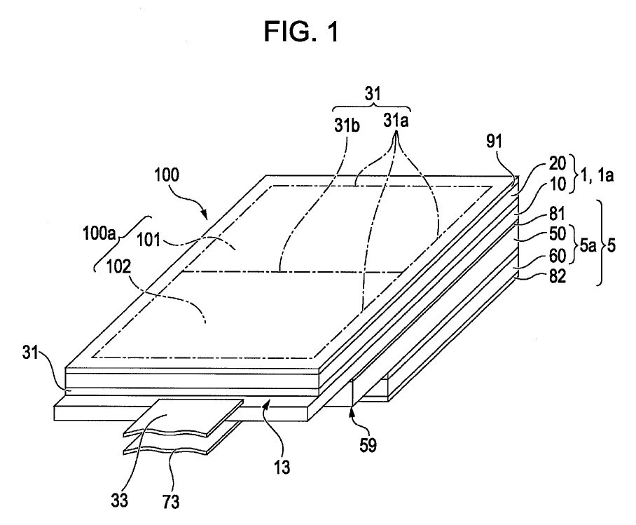

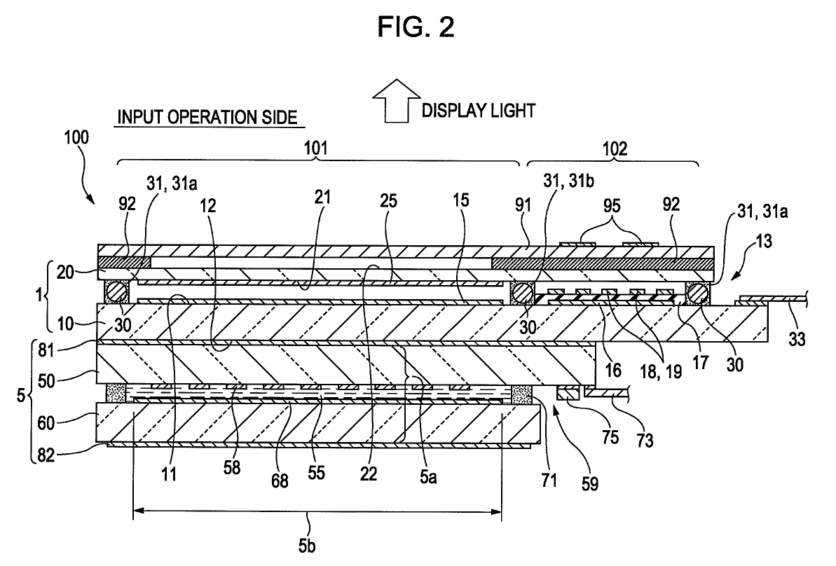

FIGS. 1 and 2 are diagrams schematically illustrating the structure of a display device with an input function according to an embodiment of the invention. In FIG. 2, for example, the number of electrodes of a touch panel and the number of pixel electrodes or opposite electrodes of a liquid crystal display device are different from the actual numbers, for clarity of description.

In FIGS. 1 and 2, a display device 100 with an input function according to the first embodiment mainly includes a liquid crystal display device 5, serving as an image generating device, and a touch panel 1 (input device) that is provided on one surface of the liquid crystal display device 5 from which display light is emitted.

The liquid crystal display device 5 includes a transmissive, reflective, or transflective active matrix liquid crystal panel 5a. In this embodiment, since the liquid crystal panel 5a is a transmissive type, a backlight unit (not shown) is provided on one surface of the liquid crystal panel that is opposite to the other surface from which display light is emitted. In addition, in the liquid crystal display device 5, a first polarizing plate 81 is provided on the other surface of the liquid crystal panel 5a from which display light is emitted, and a second polarizing plate 82 is provided on the one surface of the liquid crystal panel opposite to the light emission surface.

The liquid crystal panel 5a includes a transmissive element substrate 50 that is provided on the emission side of display light and a transmissive opposite substrate 60 that is arranged opposite to the element substrate 50. The opposite substrate 60 and the element substrate 50 are bonded to each other by a frame-shaped sealing material 71, and a liquid crystal layer 55 (electro-optical material layer) is provided in an area surrounded by the sealing material 71 between the opposite substrate 60 and the element substrate 50.

A plurality of pixel electrodes 58 are formed on one surface of the element substrate 50 that faces the opposite substrate 60, and a common electrode 68 is formed on one surface of the opposite substrate 60 that faces the element substrate 50. The common electrode 68 may be formed on the element substrate 50. In addition, the opposite substrate 60 may be provided on the emission side of display light.

On the element substrate 50, a driving IC 75 is mounted on a protruding region 59 that protrudes from the edge of the opposite substrate 60 by a COG technique, and a flexible substrate 73 is connected to the protruding region 59. A driving circuit may be formed simultaneously with switching elements on the element substrate 50.

### Detailed Structure of Touch Panel 1

In the touch panel 1 according to this embodiment, an input area 100a includes a resistive film type input area 101 and a capacitance type input area 102, which will be described below, and the resistive film type input area 101 and the capacitance type input area 102 are arranged so as to be separated from each other in plan view.

In this embodiment, the touch panel 1 includes a first transmissive substrate 10 that is formed of, for example, a glass plate or a plastic plate, and a second transmissive substrate 20 that is formed of, for example, a glass plate or a plastic plate. In this embodiment, both the first substrate 10 and the second substrate 20 are formed of glass plates. The first substrate 10 and the second substrate 20 are bonded to each other by a frame-shaped sealing material 31 such that their first surfaces 11 and 21 are opposite to each other with a predetermined gap therebetween. The second substrate 20 is arranged on the input operation side, and the first substrate 10 is arranged on the liquid crystal display device 5. Therefore, a second surface 22 of the second substrate 20 faces the input operation side, and a second surface 12 of the first substrate 10 faces the liquid crystal display device 5. In the touch panel 1 having the above-mentioned structure, when an input operation is performed in the resistive film type input area 101, it is necessary to bend the second substrate 20. Therefore, the second substrate 20 has a thickness smaller than the first substrate 10 and has flexibility.

On the first surface 11 of the first substrate 10, a flexible substrate 33 is connected to a protruding region 13 that protrudes from the edge of the second substrate 20. The flexible substrate 33 is a common wiring member that outputs signals from the resistive film type input area 101 and the capacitance type input area 102 to the outside.

The sealing material 31 includes an outer frame portion 31a that is provided along the edge of the second substrate 20 and a partition frame portion 31b that connects the middle points of two sides of the outer frame portion 31a. Almost the entire area surrounded by the sealing material 31 serves as the input area 100a. In addition, in the input area 100a, the resistive film type input area 101 is arranged on one side of the partition frame portion 31b (the side that is far away from the end of the input area to which the flexible substrate 33 is connected), and the capacitance type input area 102 is arranged on the other side (to which the flexible substrate 33 is connected) of the partition frame portion 31b.

In the resistive film type input area 101 of the touch panel 1, a first transmissive electrode 15 that is composed of an ITO (indium tin oxide) film is formed on the first surface 11 of the first substrate 10, and a second transmissive electrode 25 that is composed of an ITO film is formed on the first surface 21 of the second substrate 20. In addition, an air layer is provided therebetween.

A wiring pattern (not shown) is formed on the first surface 11 of the first substrate 10 so as to extend from the first electrode 15 to the protruding region 13, and the wiring pattern makes it possible to output signals from the first electrode 15 to the flexible substrate 33. In addition, an inter-substrate conductive material 30, such as plastic beads having surfaces coated with a metal layer, is mixed with the sealing material 31. The inter-substrate conductive material 30 is interposed between the first surface 11 of the first substrate 10 and the first surface 21 of the second substrate 20, and electrically connects the second electrode 25 formed on the first surface 21 of the second substrate 20 and the wiring pattern (not shown) formed on the first surface 11 of the first substrate 10. The inter-substrate conductive material 30 and the wiring pattern make it possible to output signals from the second electrode 25 to the flexible substrate 33.

In the resistive film type input area 101 having the above-mentioned structure, when the second substrate 20 is pressed, the first electrode 15 contacts the second electrode 25 in the pressed portion. Therefore, it is possible to detect input coordinates by detecting the contact position. Thus, a user can press a predetermined portion of the second substrate 20 of the resistive film type input area 101 with, for example, fingers or a pen to input information.

In the capacitance type input area 102 of the touch panel 1, a transmissive shield layer 16 composed of an ITO film, a transmissive insulating film 17 composed of, for example, a silicon oxide film, and transmissive third electrodes 18 and 19 composed of an ITO film are sequentially formed on the first surface 11 of the first substrate 10. The shield layer 16 has a function of preventing the influence of external noise.

The third electrodes 18 and 19 are composed of, for example, a plurality of rows of electrode patterns that extend so as to intersect each other. FIG. 2 schematically illustrates the third electrodes 18 and 19 without discriminating them. For example, the third electrodes 18 and 19 may have a structure that includes a large-area portion, such as a pad, or a structure in which triangular patterns that are opposite to each other in the horizontal direction are alternately arranged. In any case, a wiring pattern (not shown) extends from the third electrodes 18 and 19 to the protruding region 13, and the wiring pattern makes it possible to output signals from the third electrodes 18 and 19 to the flexible substrate 33.

In the capacitance type input area 102 having the above-mentioned structure, when a voltage is sequentially applied to a plurality of third electrodes 18 and 19 and a finger, which is a conductor, contacts or approaches any portion of the capacitance type input area, capacitance is formed between the electrodes 18 and 19 and the finger, and the capacitance detected by the third electrodes 18 and 19 is lowered. Therefore, it is possible to detect where the finger is contacted or approached. The capacitance type input area 102 makes it possible for the user to input information with a finger in a non-contact manner. However, the capacitance type input area 102 has a disadvantage in that it is difficult to input information with a pen formed of an insulating material.

A sheet 91 is provided on the input operation side of the touch panel 1 having the above-mentioned structure, and a light shielding layer 92 is formed in a frame shape on the inner surface of the sheet 91 (one surface of the sheet 91 facing the touch panel 1). The light shielding layer 92 is formed in an area overlapping the capacitance type input area 102, but is not formed in an area overlapping the resistive film type input area 101. Therefore, the capacitance type input area 102 serves as a light shielding area, and the resistive film type input area 101 serves as a transmissive area. In addition, an image display area 5b of the liquid crystal display device 5 overlaps the resistive film type input area 101. Therefore, in the display device 100 with an input function according to this embodiment, it is possible for a viewer to view the image displayed by the liquid crystal display device 5 from the input operation side through the resistive film type input area 101. In the capacitance type input area 102, a symbol indicating a cursor key 95 is printed on the outer surface of the sheet 91 (the input operation side surface). Meanwhile, a hard coating layer may be formed on the outer surface of the sheet 91, if necessary. When the sheet 91 is configured to serve as the first polarizing plate 81, that is, when the sheet 91 also serves as the first polarizing plate 81, the first polarizing plate 81 may be omitted. As a result, it is possible to reduce the thickness of the touch panel 1. However, the invention is not limited to the structure in which the sheet 91 also serves as the first polarizing plate 81. For example, any of the members provided on the surface of the liquid crystal panel 5a from which display light is emitted may have the function of the first polarizing plate 81.

### Main Effects of First Embodiment

As described above, in this embodiment, one touch panel 1 includes both the resistive film type input area 101 and the capacitance type input area 102. Therefore, in the capacitance type input area 102, the user touches the cursor key 95 with a finger to scroll the screen displayed on the liquid crystal display device 5. In addition, in the resistive film type input area 101, the user pushes a selection button displayed on the liquid crystal display device 5 with, for example, a pen to input information. That is, according to the touch panel 1 of this embodiment, it is possible to input information using various methods. As a result, it is possible to improve usability.

Further, since the resistive film type input area 101 and the capacitance type input area 102 are separated from each other in plan view, it is possible to scroll the screen in the capacitance type input area 102, while viewing the screen displayed by the liquid crystal display device 5, and then input information in the resistive film type input area 101 with a pen. Therefore, it is possible to perform optimal information input both in the resistive film type input area 101 and the capacitance type input area 102.

Furthermore, the third electrodes 18 and 19 for forming the capacitance type input area 102 are formed on the first surface 11 of the first substrate 10 on which the first electrode 15 forming the resistive film type input area 101 is formed. Therefore, it is possible to reduce the number of substrates, as compared to a structure in which a resistive film type touch panel and a capacitance type touch panel that are separately manufactured and arranged in a plane. In addition, the shield layer 16 or the third electrodes 18 and 19 can be formed simultaneously with the first electrode 15. Therefore, it is possible to reduce the number of manufacturing processes. As a result, it is possible to reduce the manufacturing costs of the touch panel 1.

Further, for example, a common partition frame portion 31b is used for the resistive film type input area 101 and the capacitance type input area 102. Therefore, it is possible to ensure a large input area, as compared to a structure in which the resistive film type input area 101 and the capacitance type input area 102 are sealed by individual seal materials. Similarly, since the inter-substrate conductive material 30 is used to electrically connect the first substrate 10 and the second substrate, it is possible to output signals from the resistive film type input area 101 and the capacitance type input area 102 to the outside using the common flexible substrate 33. Therefore, it is not necessary to individually provide flexible substrate contact areas in the resistive film type input area 101 and the capacitance type input area 102. As a result, it is possible to ensure a large input area.

Furthermore, the flexible substrate 33 is connected to the first surface 11 of the first substrate 10, and the first substrate 10 is thicker than the second substrate 20. Therefore, according to this embodiment, it is possible to improve the reliability of a connection portion of the flexible substrate, as compared to a structure in which the flexible substrate 33 is connected to the second substrate 20.

### Second Embodiment

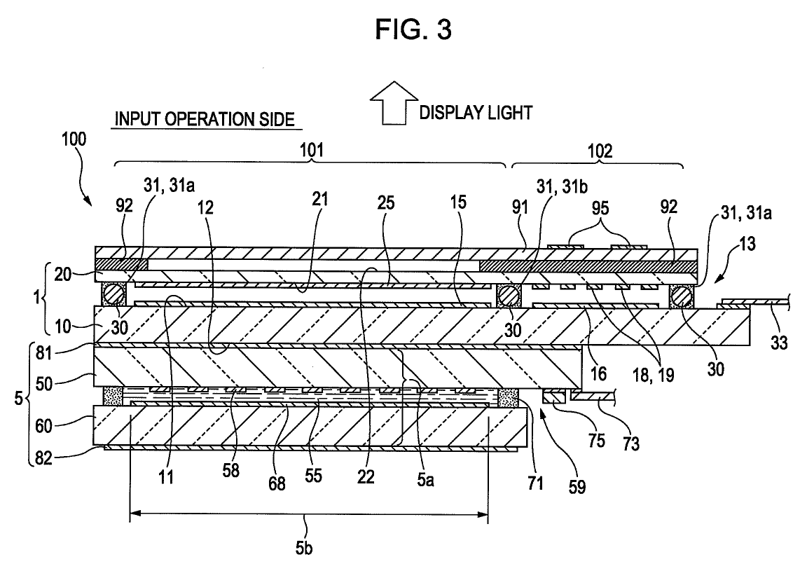

In the first embodiment, the third electrodes 18 and 19 forming the capacitance type input device 102 are formed on the first substrate 10. However, in this embodiment, as will be described below with reference to FIG. 3, the third electrodes 18 and 19 are formed on the first surface of the second substrate 20.

FIG. 3 is a cross-sectional view schematically illustrating the structure of a display device 100 with an input function according to the second embodiment of the invention. The basic structure according to this embodiment is the same as that in the first embodiment. Therefore, in the second embodiment, the same components as those in the first embodiment are denoted by the same reference numerals, and a description thereof will be omitted.

As shown in FIG. 3, in this embodiment, similar to the first embodiment, the display device 100 with an input function includes a liquid crystal display device 5 and a touch panel 1 that is provided on one surface of the liquid crystal display device 5 from which display light is emitted. In addition, in the touch panel 1, an input area 100a includes a resistive film type input area 101 and a capacitance type input area 102, which will be described below, and the resistive film type input area 101 and the capacitance type input area 102 are separated from each other in plan view.

In this embodiment, similar to the first embodiment, in the resistive film type input area 101 of the touch panel 1, a first transmissive electrode 15 that is composed of an ITO film is formed on the first surface 11 of the first substrate 10, and a second transmissive electrode 25 that is composed of an ITO film is formed on the first surface 21 of the second substrate 20. In addition, an air layer is provided therebetween. A wiring pattern (not shown) is formed on the first surface 11 of the first substrate 10 so as to extend from the first electrode 15 to the protruding region 13, and the wiring pattern makes it possible to output signals from the first electrode 15 to the flexible substrate 33. In addition, an inter-substrate conductive material 30 mixed with a sealing material 31 is interposed between the first surface 11 of the first substrate 10 and the first surface 21 of the second substrate 20, and electrically connects the second electrode 25 formed on the first surface 21 of the second substrate 20 and the wiring pattern (not shown) formed on the first surface 11 of the first substrate 10. The inter-substrate conductive material 30 and the wiring pattern make it possible to output signals from the second electrode 25 to the flexible substrate 33.

In this embodiment, in the capacitance type input area 102, the third transmissive electrodes 18 and 19 are formed on the first surface 21 of the second substrate 20. However, the inter-substrate conductive material 30 mixed with the sealing material 31 is interposed between the first surface 11 of the first substrate 10 and the first surface 21 of the second substrate 20 to electrically connect the third electrodes 18 and 19 formed on the first surface 21 of the second substrate 20 to the wiring pattern (not shown) formed on the first surface 11 of the first substrate 10. Therefore, the inter-substrate conductive material 30 and the wiring pattern make it possible to output signals from the third electrodes 18 and 19 to the flexible substrate 33.

In the capacitance type input area 102, a transmissive shield layer 16 composed of an ITO film is formed on the first surface 11 of the first substrate 10. Therefore, it is possible to prevent the influence of external noise.

A sheet 91 is provided on the input operation side of the touch panel 1 having the above-mentioned structure, and a light shielding layer 92 is formed in a frame shape on the inner surface of the sheet 91 (one surface of the sheet 91 facing the touch panel 1). The light shielding layer 92 is formed in an area overlapping the capacitance type input area 102, but is not formed in an area overlapping the resistive film type input area 101. Therefore, the capacitance type input area 102 serves as a light shielding area, and the resistive film type input area 101 serves as a transmissive area. Therefore, in the display device 100 with an input function according to this embodiment, it is possible for a viewer to view the image displayed by the liquid crystal display device 5 from the input operation side through the resistive film type input area 101. In the capacitance type input area 102, a symbol indicating a cursor key 95 is printed on the outer surface of the sheet 91 (the surface on the input operation side). The other structures are substantially the same as those in the first embodiment, and thus a description thereof will be omitted.

In the display device 100 with an input function having the above-mentioned structure, similar to the first embodiment, since the resistive film type input area 101 and the capacitance type input area 102 are separated from each other in plan view, it is possible to obtain the same effects as those in the first embodiment, such as improvement in usability.

Furthermore, the third electrodes 18 and 19 for forming the capacitance type input area 102 are formed on the second substrate 20 on which the second electrode 25 forming the resistive film type input area 101 is formed. Therefore, it is possible to reduce the number of substrates, as compared to a structure in which a resistive film type touch panel and a capacitance type touch panel are separately manufactured and arranged in a plane. In addition, the third electrodes 18 and 19 can be formed simultaneously with the second electrode 25. Therefore, it is possible to reduce the number of manufacturing processes. As a result, it is possible to obtain the same effects as those in the first embodiment, such as a reduction in the manufacturing costs of the touch panel 1.

### Third Embodiment

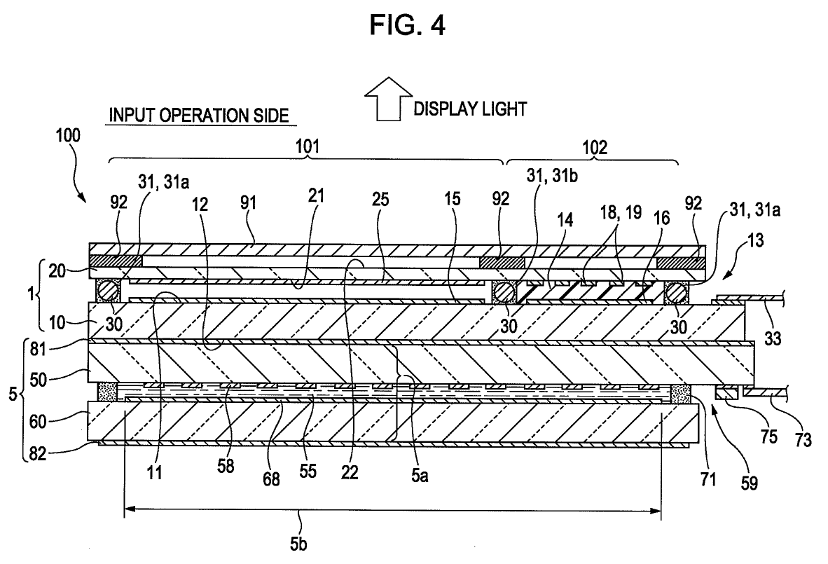

In the first and second embodiments, the capacitance type input area 102 serves as a light shielding area, and the resistive film type input area 101 serving as a transmissive area. Therefore, it is possible to view the image displayed by the liquid crystal display device 5 from the input operation side only through the resistive film type input area 101. However, as will be described below with reference to FIG. 4, in a third embodiment, both the capacitance type input area 102 and the resistive film type input area 101 serve as the transmissive areas. Therefore, according to this embodiment, it is possible to view the image displayed by the liquid crystal display device 5 from the input operation side through both the resistive film type input area 101 and the capacitance type input area 102.

FIG. 4 is a cross-sectional view schematically illustrating the structure of a display device 100 with an input function according to the third embodiment of the invention. The basic structure of this embodiment is the same as that in the first and second embodiments. Therefore, in the third embodiment, the same components as those in the first and second embodiments are denoted by the same reference numerals, and a description thereof will be omitted.

As shown in FIG. 4, in this embodiment, similar to the first and second embodiments, the display device 100 with an input function includes a liquid crystal display device 5 and a touch panel 1 that is provided on one surface of the liquid crystal display device 5 from which display light is emitted. In addition, in the touch panel 1, an input area 100a includes a resistive film type input area 101 and a capacitance type input area 102, which will be described below, and the resistive film type input area 101 and the capacitance type input area 102 are separated from each other in plan view.

In this embodiment, similar to the first and second embodiments, in the resistive film type input area 101 of the touch panel 1, a first transmissive electrode 15 that is composed of an ITO film is formed on a first surface 11 of a first substrate 10, and a second transmissive electrode 25 that is composed of an ITO film is formed on a first surface 21 of a second substrate 20. In addition, an air layer is provided therebetween. Further, an inter-substrate conductive material 30 mixed with a sealing material 31 is interposed between the first surface 11 of the first substrate 10 and the first surface 21 of the second substrate 20, and electrically connects the second electrode 25 formed on the first surface 21 of the second substrate 20 and a wiring pattern (not shown) formed on the first surface 11 of the first substrate 10. The inter-substrate conductive material 30 and the wiring pattern make it possible to output signals from the second electrode 25 to a flexible substrate 33.

In this embodiment, in the capacitance type input area 102, similar to the second embodiment, third transmissive electrodes 18 and 19 are formed on the first surface of the second substrate 20. However, the inter-substrate conductive material 30 mixed with the sealing material 31 is interposed between the first surface 11 of the first substrate 10 and the first surface 21 of the second substrate 20 to electrically connect the third electrodes 18 and 19 formed on the first surface 21 of the second substrate 20 to the wiring pattern (not shown) formed on the first surface 11 of the first substrate 10. Therefore, the inter-substrate conductive material 30 and the wiring pattern make it possible to output signals from the third electrodes 18 and 19 to the flexible substrate 33. In the capacitance type input area 102, a transmissive shield layer 16 composed of an ITO film is formed on the first surface 11 of the first substrate 10.

In the capacitance type input area 102, an insulating high refractive index material 14, such as methacrylate resin, is filled between the first substrate 10 and the second substrate 20. The high refractive index material 14 is a liquid material that is injected through an opening of the sealing material 31, or it is a hardened material of the injected liquid material. After the liquid material is injected, the opening of the sealing material 31 is sealed.

A sheet 91 is provided on the input operation side of the touch panel 1 having the above-mentioned structure, and a light shielding layer 92 is formed in a frame shape on the inner surface of the sheet 91 (one surface of the sheet 91 facing the touch panel 1). However, in this embodiment, the light shielding layer 92 is formed in only an area overlapping the sealing material 31, and serves as only a frame.

Therefore, the light shielding layer 92 is not formed in an area overlapping the capacitance type input area 102 and the resistive film type input area 101. Therefore, both the capacitance type input area 102 and the resistive film type input area 101 serve as transmissive areas. In addition, in the liquid crystal display device 5, the entire area overlapping the capacitance type input area 102 and the resistive film type input area 101 serves as an image display area 5b. Therefore, in the display device 100 with an input function according to this embodiment, it is possible for a viewer to view the image displayed by the liquid crystal display device 5 from the input operation side through both the resistive film type input area 101 and the capacitance type input area 102. Since the light shielding layer 92 serves as a frame of the capacitance type input area 102 and the resistive film type input area 101, it is possible to prevent the sealing material 31 of the touch panel 1 and a wiring pattern (not shown) provided in the vicinity of the sealing material from being viewed from the input operation side. In addition, the light shielding layer 92 divides images displayed in the capacitance type input area 102 and the resistive film type input area 101. Therefore, since the capacitance type input area 102 and the resistive film type input area 101 are visually divided from each other, the operator can recognize that the capacitance type input area 102 and the resistive film type input area 101 have different functions, which makes it possible to improve operability. The other structures are substantially the same as those in the first embodiment, and thus a description thereof will be omitted.

In the display device 100 with an input function having the above-mentioned structure, similar to the first and second embodiments, since the resistive film type input area 101 and the capacitance type input area 102 are separated from each other in plan view, it is possible to obtain the same effects as those in the first and second embodiments, such as improvement in usability.

Furthermore, similar to the second embodiment, the third electrodes 18 and 19 forming the capacitance type input area 102 are formed on the second substrate 20 on which the second electrode 25 forming the resistive film type input area 101 is formed. Therefore, it is possible to reduce manufacturing costs, as compared to a structure in which a resistive film type touch panel and a capacitance type touch panel that are separately manufactured and arranged in a plane. That is, it is possible to obtain the same effects as those in the first and second embodiments.

Further, it is possible to view the image displayed by the liquid crystal display device 5 from the input operation side through both the capacitance type input area 102 and the resistive film type input area 101. Therefore, it is possible to input information in both the capacitance type input area 102 and the resistive film type input area 101, while viewing the image displayed by the liquid crystal display device 5 from the input operation side. In this case, an insulating high refractive index material 14 is also filled between the first substrate 10 and the second substrate 20 in the capacitance type input area 102. Therefore, there is no reflective interface and thus it is possible to display an image with high brightness.

### Fourth Embodiment

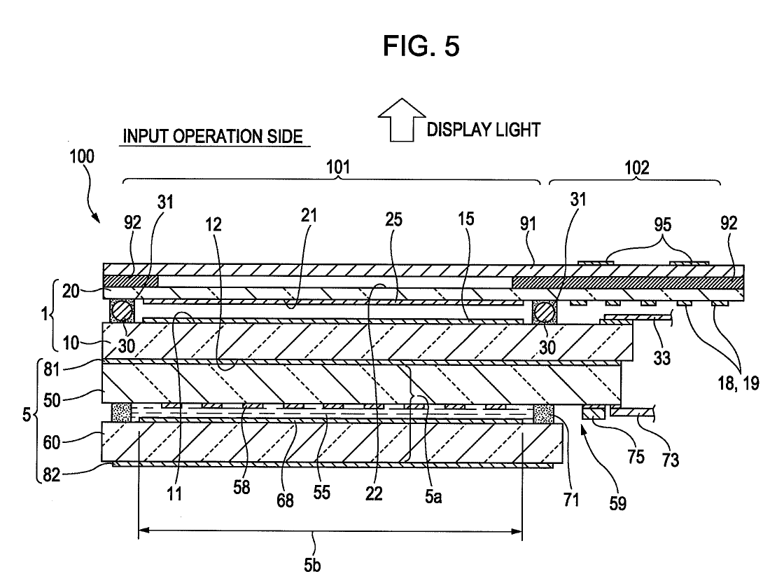

In the first to third embodiments, the first substrate 10 is larger than the second substrate 20. However, in this embodiment, as will be described below with reference to FIG. 5, the first substrate 10 is smaller than the second substrate 20. In addition, in the first to third embodiments, each of the resistive film type input area 101 and the capacitance type input area 102 is surrounded by the sealing material 31. However, in this embodiment, as will be described below with reference to FIG. 5, the resistive film type input area 101 is surrounded by the sealing material 31, but the capacitance type input area 102 is not surrounded by the sealing material 31.

FIG. 5 is a cross-sectional view schematically illustrating the structure of a display device 100 with an input function according to the fourth embodiment of the invention. The basic structure of this embodiment is the same as that in the first and second embodiments. Therefore, in the fourth embodiment, the same components as those in the first and second embodiments are denoted by the same reference numerals, and a description thereof will be omitted.

As shown in FIG. 5, in this embodiment, similar to the first and second embodiments, the display device 100 with an input function includes a liquid crystal display device 5 and a touch panel 1 that is provided on one surface of the liquid crystal display device 5 from which display light is emitted. In addition, in the touch panel 1, an input area 100a includes a resistive film type input area 101 and a capacitance type input area 102, which will be described below, and the resistive film type input area 101 and the capacitance type input area 102 are separated from each other in plan view.

In this embodiment, the first substrate 10 is smaller than the second substrate 20, and a flexible substrate 33 is connected to the end of the first surface 11 of the first substrate 10. Therefore, the flexible substrate 33 is connected to the first surface 11 of the first substrate 10 at a position facing the second substrate 20.

The sealing material 31 is formed so as to surround only the resistive film type input area 101, but the capacitance type input area 102 is not surrounded by the sealing material 31.

In this embodiment, similar to the first embodiment, an inter-substrate conductive material 30 mixed with the sealing material 31 is interposed between the first surface 11 of the first substrate 10 and the first surface 21 of the second substrate 20, and electrically connects the second electrode 25 formed on the first surface 21 of the second substrate 20 and a wiring pattern (not shown) formed on the first surface 11 of the first substrate 10. The inter-substrate conductive material 30 and the wiring pattern make it possible to output signals from the second electrode 25 to the flexible substrate 33.

In this embodiment, in the capacitance type input area 102, the third transmissive electrodes 18 and 19 are formed on the first surface of the second substrate 20. However, the inter-substrate conductive material 30 mixed with the sealing material 31 is interposed between the first surface 11 of the first substrate 10 and the first surface 21 of the second substrate 20 to electrically connect the third electrodes 18 and 19 formed on the first surface 21 of the second substrate 20 to the wiring pattern (not shown) formed on the first surface 11 of the first substrate 10. Therefore, the inter-substrate conductive material 30 and the wiring pattern make it possible to output signals from the third electrodes 18 and 19 to the flexible substrate 33.

A sheet 91 is provided on the input operation side of the touch panel 1 having the above-mentioned structure, and a light shielding layer 92 is formed in a frame shape on the inner surface of the sheet 91 (one surface of the sheet 91 facing the touch panel 1). The light shielding layer 92 is formed in an area overlapping the capacitance type input area 102, but is not formed in an area overlapping the resistive film type input area 101. Therefore, the capacitance type input area 102 serves as a light shielding area, and the resistive film type input area 101 serves as a transmissive area. Therefore, in the display device 100 with an input function according to this embodiment, it is possible for a viewer to view the image displayed by the liquid crystal display device 5 from the input operation side through the resistive film type input area 101. In the capacitance type input area 102, a symbol indicating a cursor key 95 is printed on the outer surface of the sheet 91 (the surface on the input operation side). The other structures are substantially the same as those in the first, second, and fourth embodiments, and thus a description thereof will be omitted.

In the display device 100 with an input function having the above-mentioned structure, similar to the first and second embodiments, since the resistive film type input area 101 and the capacitance type input area 102 are separated from each other in plan view, it is possible to obtain the same effects as those in the first and second embodiments, such as improvement in usability.

Furthermore, the third electrodes 18 and 19 forming the capacitance type input area 102 are formed on the second substrate 20 on which the second electrode 25 forming the resistive film type input area 101 is formed. Therefore, it is possible to reduce manufacturing costs, as compared to a structure in which a resistive film type touch panel and a capacitance type touch panel are separately manufactured and arranged in a plane. That is, it is possible to obtain the same effects as those in the first and second embodiments.

### Fifth Embodiment

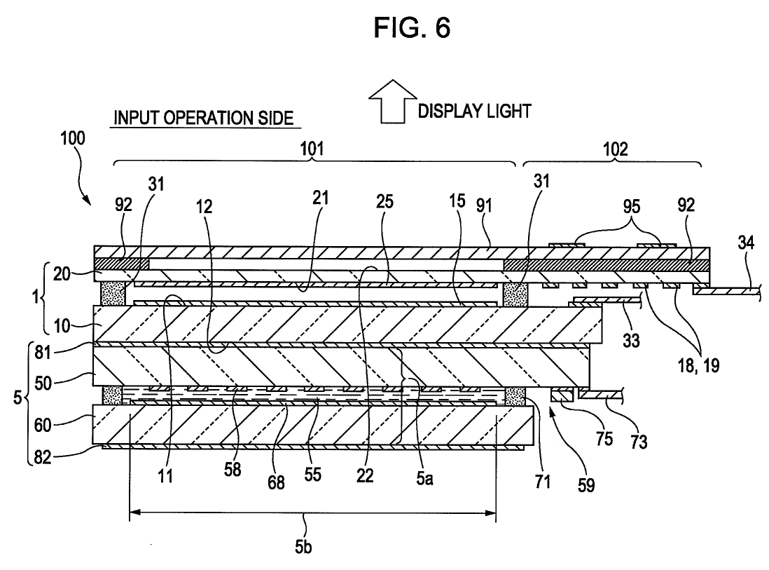

In the first to fourth embodiments, the flexible substrate 33 connected to the first substrate 10 is used to output signals from the resistive film type input area 101 and the capacitance type input area 102 to the outside. However, as will be described below with reference to FIG. 6, in this embodiment, the flexible substrate 33 connected to the first substrate 10 is used to output signals from the first electrode 15 of the resistive film type input area 101 to the outside, and a flexible substrate connected to the second substrate 20 is used to output signals from the capacitance type input area 102 to the outside.

FIG. 6 is a cross-sectional view schematically illustrating the structure of a display device 100 with an input function according to the fifth embodiment of the invention. The basic structure of this embodiment is the same as that in the first, second, and fourth embodiments. Therefore, in the fifth embodiment, the same components as those in the first, second, and fourth embodiments are denoted by the same reference numerals, and a description thereof will be omitted.

As shown in FIG. 6, in this embodiment, similar to the first and second embodiments, the display device 100 with an input function includes a liquid crystal display device 5 and a touch panel 1 that is provided on one surface of the liquid crystal display device 5 from which display light is emitted. In addition, in the touch panel 1, an input area 100a includes a resistive film type input area 101 and a capacitance type input area 102, which will be described below, and the resistive film type input area 101 and the capacitance type input area 102 are separated from each other in plan view.

In this embodiment, a sealing material 31 is formed so as to surround only the resistive film type input area 101, but the capacitance type input area 102 is not surrounded by the sealing material 31. In addition, no inter-substrate conductive material is mixed with the sealing material 31.

In this embodiment, the first substrate 10 is smaller than the second substrate 20, and the flexible substrate 33 is connected to the end of the first surface 11 of the first substrate 10. Further, in this embodiment, a flexible substrate 34 is connected to the end of the first surface 21 of the second substrate 20.

In this embodiment, similar to the first embodiment, in the resistive film type input area 101 of the touch panel 1 having the above-mentioned structure, the first transmissive electrode 15 that is composed of an ITO film is formed on the first surface 11 of the first substrate 10, and the second transmissive electrode 25 that is composed of an ITO film is formed on the first surface 21 of the second substrate 20. In addition, an air layer is provided therebetween. A wiring pattern (not shown) is formed on the first surface 11 of the first substrate 10 so as to extend from the first electrode 15 to a connection region of the flexible substrate 33, and the wiring pattern makes it possible to output signals from the first electrode 15 to the flexible substrate 33.

Further, the second electrode 25 is formed on the first surface 21 of the second substrate 20, and a wiring pattern (not shown) is formed on the first surface 21 of the first substrate 20 so as to extend from the second electrode 25 to a connection region of the flexible substrate 34. Therefore, the wiring pattern and the flexible substrate 34 make it possible to output signals from the second electrode 25 to the outside. Alternatively, an inter-substrate conductive material 30 mixed with the sealing material 31 may connect the second electrode 25 formed on the first surface 21 of the second substrate 20 to a wiring pattern (not shown) formed on the first surface 11 of the first substrate 10, thereby outputting signals from the second electrode 25 to the flexible substrate 33.

In the capacitance type input area 102, the third transmissive electrodes 18 and 19 are formed on the first surface 21 of the second substrate 20. However, a wiring pattern (not shown) is formed on the first surface 21 of the second substrate 20 so as to extend from the third electrodes 18 and 19 to a connection region of the flexible substrate 34, and the wiring pattern and the flexible substrate 34 make it possible to output signals from the third electrodes 18 and 19 to the outside. The other structures are substantially the same as those in the first and second embodiments, and thus a description thereof will be omitted.

In the display device 100 with an input function having the above-mentioned structure, similar to the first and second embodiments, the resistive film type input area 101 and the capacitance type input area 102 are separated from each other in plan view. Therefore, it is possible to obtain the same effects as those in the first and second embodiments, such as improvement in usability.

Furthermore, the third electrodes 18 and 19 forming the capacitance type input area 102 are formed on the second substrate 20 on which the second electrode 25 forming the resistive film type input area 101 is formed. Therefore, it is possible to reduce manufacturing costs, as compared to a structure in which a resistive film type touch panel and a capacitance type touch panel that are separately manufactured are arranged in a plane. That is, it is possible to obtain the same effects as those in the first and second embodiments.

### Sixth Embodiment

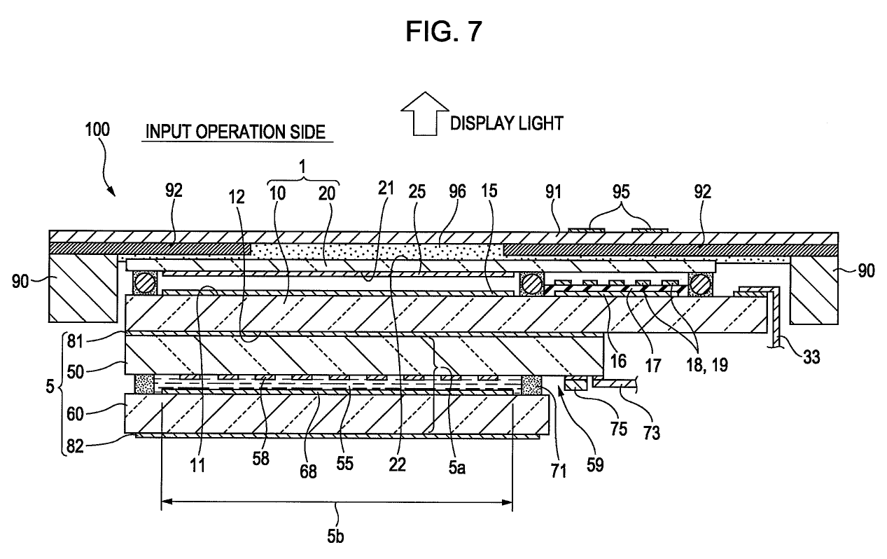

FIG. 7 is a cross-sectional view schematically illustrating the structure of a display device with an input function according to a sixth embodiment of the invention. In the first to fifth embodiments, the sheet 91 is provided on the input operation side of the touch panel 1. However, as shown in FIG. 7, when the sheet 91 is fixed to the touch panel 1, the sheet 91 may be adhered to the input operation side of a frame 90 surrounding the touch panel 1, and the sheet 91 may be adhered to the touch panel 1 by an adhesive 96. According to this structure, it is possible to implement a display device with an input function having various shapes according to the shape of the frame 90, regardless of the shape of the touch panel 1 in a plan view. For example, it is possible to implement a display device with an input function having R-shaped corners.

Although not shown in FIG. 7, a first polarizing plate 81 may be fixed to the sheet 91 shown in FIG. 7 by an adhesive, thereby arranging the first polarizing plate 81 on the input operation side of the touch panel 1. In this case, the first polarizing plate 81 arranged between the touch panel 1 and the liquid crystal display device 5 is omitted.

### Seventh Embodiment

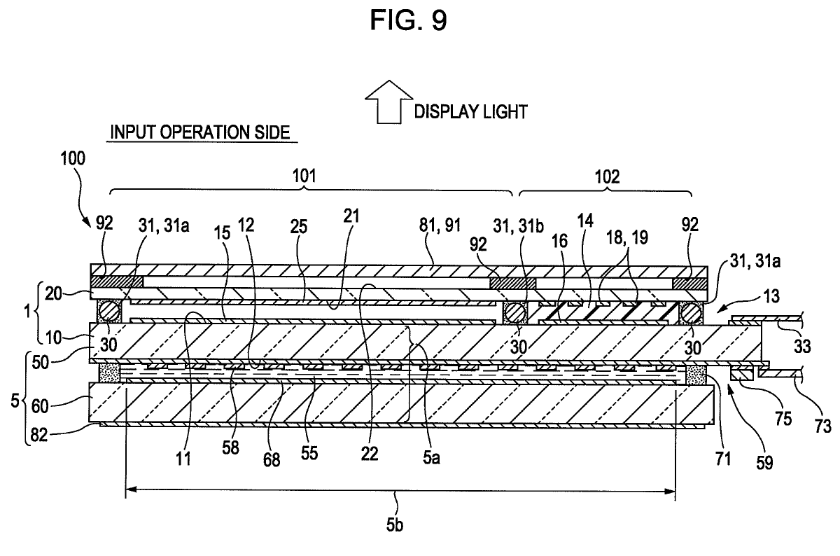

FIG. 9 is a cross-sectional view schematically illustrating the structure of a display device with an input function according to a seventh embodiment of the invention. In the first to sixth embodiments, the first substrate 10 of the touch panel 1 is arranged separately from the element substrate 50 of the liquid crystal panel 5. However, as shown in FIG. 9, the first substrate 10 of the touch panel 1 may also serve as the element substrate 50 of the liquid crystal panel 5. According to this structure, it is possible to reduce the overall thickness of the display device 100 with an input function. In this structure, the first polarizing plate (not shown) that has been arranged between the first substrate 10 and the element substrate 50 of the liquid crystal panel 5 is provided on the front surface or the rear surface of a base 40.

When the sheet 91 is configured to have the function of the first polarizing plate 81, that is, when the sheet 91 also serves as the first polarizing plate 81, it is possible to omit the first polarizing plate 81. Therefore, it is possible to further reduce the thickness of the display device 100 with an input function. The other structures are substantially the same as those in the third embodiment, and thus a description thereof will be omitted.

### Other Structures

The first to seventh embodiments are configured such that the user scrolls the screen in the capacitance type input area 102 and inputs information with a pen in the resistive film type input area 101. However, the invention is not limited thereto. For example, the following structure may be used: the user moves a cursor in the resistive film type input area 101 and inputs formation in the capacitance type input area 102. In addition, the following structure may be used: the resistive film type input area 101 is in an off state in a normal mode; and when the approach of a finger is detected by the capacitance type input area 102, the resistive film type input area 101 is turned on.

In the first to seventh embodiments, the liquid crystal display device 5 is used as an image generating device, but the invention is not limited thereto. For example, an organic electroluminescent device or a plasma display device may be used as the image generating device.

Examples of Electronic Apparatuses Provided with Display Device with Input Function

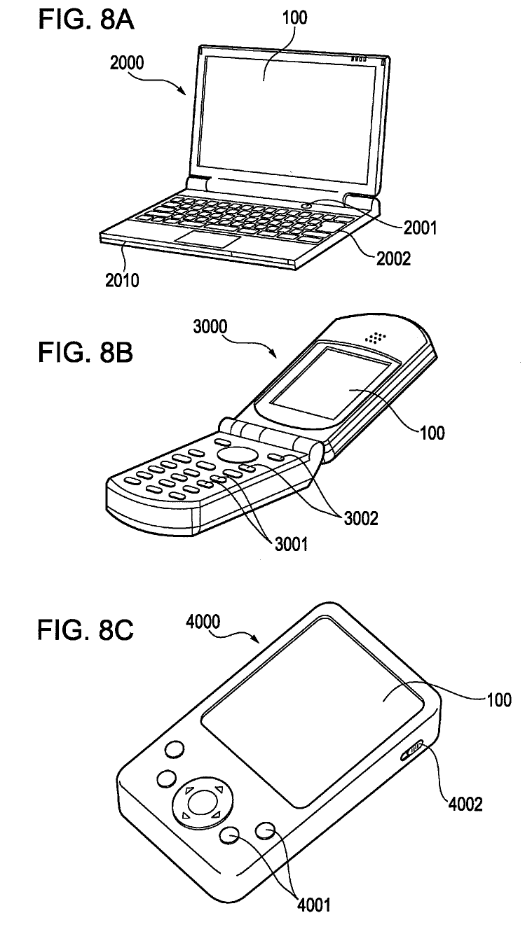

Next, electronic apparatuses provided with the display device 100 with an input function according to the above-described embodiments will be described. FIG. 8A shows the structure of a mobile personal computer provided with the display device 100 with an input function. A personal computer 2000 includes the display device 100 with an input function, serving as a display unit, and a main body 2010. The main body 2010 is provided with a power switch 2001 and a keyboard 2002. FIG. 8B shows the structure of a mobile phone provided with the display device 100 with an input function. A mobile phone 3000 includes a plurality of operating buttons 3001, scroll buttons 3002, and the display device 100 with an input function serving as a display unit. The scroll buttons 3002 are operated to scroll the screen displayed on the display device 100 with an input function. FIG. 8C shows the structure of a personal digital assistant (PDA) provided with the display device 100 with an input function. A personal digital assistant 4000 includes a plurality of operating buttons 4001, a power switch 4002, and the display device 100 with an input function serving as a display unit. When the power switch 4002 is turned on, various information items, such as an address book and a schedule, are displayed on the display device 100 with an input function.

In addition to the electronic apparatuses shown in FIGS. 8A to 8C, the display device 100 with an input function can be applied to various electronic apparatuses, such as a digital still camera, a liquid crystal television, a viewfinder-type or a monitor-direct-view-type video recorder, a navigation apparatus, a pager, an electronic organizer, a calculator, a word processor, a workstation, a video telephone, a POS terminal, and a banking terminal. The display device 100 with an input function can be used as display units of these electronic apparatuses.

What is claimed is:

1. A touch panel comprising:
a first substrate having a first surface and a second surface;
a second substrate having a first surface and a second surface;
a first electrode that is formed on the first surface of the first substrate;
a second electrode that is formed on the first surface of the second substrate;
a resistive film type input area in which the first electrode of the first substrate and the second electrode of the second substrate face each other; and
a capacitance type input area in which third electrodes are formed on at least one of the first substrate and the second substrate,
wherein the resistive film type input area and the capacitance type input area are separated from each other in plan view.

2. The touch panel according to claim 1,
wherein the third electrodes are formed on the first surface of the first substrate or the first surface of the second substrate.

3. The touch panel according to claim 2,
wherein a wiring member that outputs signals from the resistive film type input area and the capacitance type input area to the outside is connected to one of the first surface of the first substrate and the first surface of the second substrate on which the third electrodes are formed.

4. The touch panel according to claim 2,
wherein a wiring member that outputs signals from the resistive film type input area and the capacitance type input area to the outside is connected to one of the first surface of the first substrate and the first surface of the second substrate on which the third electrodes are not formed, and
an inter-substrate conductive material that outputs signals from the capacitance type input area to the outside is provided between the first surface of the first substrate and the first surface of the second substrate.

5. The touch panel according to claim 3,
wherein the wiring member is connected to the first surface of the first substrate.

6. A display device with an input function comprising:
the touch panel according to claim 1; and
an image generating device that is provided on one surface of the first substrate of the touch panel opposite to the second substrate.

7. The display device with an input function according to claim 6,
wherein at least one of the resistive film type input area and the capacitance type input area is a transmissive input area, and
the image generating device includes an image display area that overlaps the transmissive input area.

8. The display device with an input function according to claim 6,
wherein both the resistive film type input area and the capacitance type input area are transmissive input areas, and
the image generating device includes an image display area that overlaps both the transmissive input areas.

9. The display device with an input function according to claim 6,
wherein the image generating device includes a pair of substrates and an electro-optical material that is interposed between the pair of substrates, and
the first substrate also serves as one of the pair of substrates.

10. An electronic apparatus comprising the display device with an input function according to claim 6.
